(19) United States
(12) Patent Application Publication
(10) Pub. No.: US 2018/0046974 A1
(43) Pub. Date: Feb. 15, 2018

(54) DETERMINING A NON-OPTIMIZED INVENTORY SYSTEM

(71) Applicant: International Business Machines Corporation, Armonk, NY (US)

(72) Inventors: Mary E. Helander, North White Plains, NY (US); Jared R. Hurst, Marysville, OH (US); Magesh A. Narayanan, New Albany, OH (US); Priya Raman, New Albany, OH (US); Harry J. Wells, IV, Columbus, OH (US); Britney N. Williams-Ward, Reynoldsburg, OH (US)

(21) Appl. No.: 15/664,362

(22) Filed: Jul. 31, 2017

Related U.S. Application Data
(63) Continuation of application No. 15/234,237, filed on Aug. 11, 2016.

(51) Int. Cl. G06Q 10/08

(52) U.S. Cl. CPC G06Q 10/087

(57) ABSTRACT

A tool for determining a non-optimized inventory system is provided. The tool retrieves a plurality of data related to a supply chain. The tool determines an inventory history for the supply chain. The tool creates a set of linear difference equations based, at least in part, the plurality of data related to the supply chain. The tool determines a plurality of supply chain performance measurements of interest. The tool determines one or more non-optimal inventory management practices.

### BACKGROUND OF THE INVENTION

The present invention relates generally to supply chain management, and more particularly to identifying inventory management actions causing non-optimality in the performance of an inventory system.

Inventory holding is a significant driver of working capital costs in a supply chain. Working capital is traditionally the amount of money a company has tied up in running the business. The more money that is tied up, the less there is available to allocate elsewhere, or the more a company may have to borrow to fund operations. Inventory holdings may be the most prominent way the supply chain affects working capital.

### SUMMARY

Aspects of an embodiment of the present invention disclose a method, a computer system, and a computer program product for determining a non-optimal inventory system. The method includes retrieving, by one or more computer processors, a plurality of data related to a supply chain from a plurality of historical records, wherein the plurality of data related to the supply chain includes transactional sales and purchase order data for one or more products on hand at each of a plurality of locations in the supply chain of an inventory system, and wherein retrieving includes recording, over a pre-determined time period, one or more relevant events in the supply chain with a time stamp, where the one or more relevant events include an event selected from a group consisting of an inventory demand, a fulfillment event, a review event, an reorder event, and a replenishment arrival, and retrieving the one or more relevant events and a plurality of associated time stamps related to a pre-determined historical period of time in the supply chain. The method includes determining, by the one or more computer processors, an inventory history for the supply chain, wherein determining includes reconstructing the inventory history based, at least in part, on the plurality of data related to the supply chain. The method includes creating, by the one or more computer processors, a set of linear difference equations based, at least in part, on the plurality of data related to the supply chain, wherein the set of linear difference equations represent a plurality of changes of an inventory level for the one or more products on hand at each of the plurality of locations in the supply chain, and wherein the set of linear difference equations includes a first linear difference equation and a second linear difference equation, wherein the first linear difference equation is an expression of an inventory on hand on a first date equal to a multiplier times an inventory on hand on a previous date plus a summary of one or more changes that occur on the first date, and the second linear difference equation is an expression of the summary of the changes that occur on the first date equal to a total receipts value on the first date minus a total depletions value on the first date plus a total net adjustments value on the first date. The method includes determining, by the one or more computer processors, a plurality of supply chain performance measurements of interest, wherein determining includes comparing one or more reconstructed time series to one or more actual time series to identify one or more non-optimal inventory events. The method includes determining, by the one or more computer processors, one or more non-optimal inventory management practices, wherein determining includes determining a quantification correction to an inventory level of a product at each of a plurality of points in a time interval through utilizing a reconstructed inventory history and the plurality of supply chain performance measurements of interest, wherein the quantification correction to the inventory level of the product is a value to increase or decrease an actual inventory on hand in order to align the actual inventory on hand to an optimized inventory on hand. The method includes determining, by the one or more computer processors, an optimal inventory policy for a plurality of characteristics of a historical period of an inventory system. The method includes constructing, by the one or more computer processors, a model plotting the actual inventory on hand with the optimized inventory on hand at one or more points in time across the pre-determined historical period of time. The method includes simulating, by the one or more computer processors, the optimal inventory policy based, at least in part, on a posteriori optimization, where a dynamic simulation provides a time series of a plurality of reconstructed events of the inventory system compared to a plurality of actual events of the inventory system. The method includes providing, by the one or more computer processors, a notification to a user at each of the plurality of locations in the supply chain at each point in the time interval informing a quantity representing the inventory level for the one or more products on hand at each of the plurality of locations in the supply chain. The method includes providing, by the one or more computer processors, a function, defined over an input time interval, that maps a point in time to the quantification of the inventory level for the one or more products on hand at each of the plurality of locations in the supply chain.

### BRIEF DESCRIPTION OF THE DRAWINGS

FIG. 1 is a functional block diagram illustrating a data processing environment, in accordance with an embodiment of the present invention.

FIG. 2 is a flowchart depicting operational steps of an inventory optimizer program, in accordance with an embodiment of the present invention.

FIG. 3 is a block diagram depicting components of a data processing system (such as the server of FIG. 1), in accordance with an embodiment of the present invention.

### DETAILED DESCRIPTION

Embodiments of the present invention recognize that more efficient decisions regarding supply chain management can reduce working capital and result in overall performance increases in an inventory system. Embodiments of the present invention recognize that by the process of evaluating optimized prescriptions on past performance, a decision maker can gain more insight and confidence into how to efficiently and effectively manage an inventory system to create cost savings.

Embodiments of the present invention provide the capability to extend the utility of detailed data used for inventory optimization decisions. Embodiments of the present invention provide the capability to rely on details of historical event data of an inventory system and evaluate supply chain performance based on the historical event data.

Implementation of such embodiments may take a variety of forms, and exemplary implementation details are discussed subsequently with reference to the Figures.

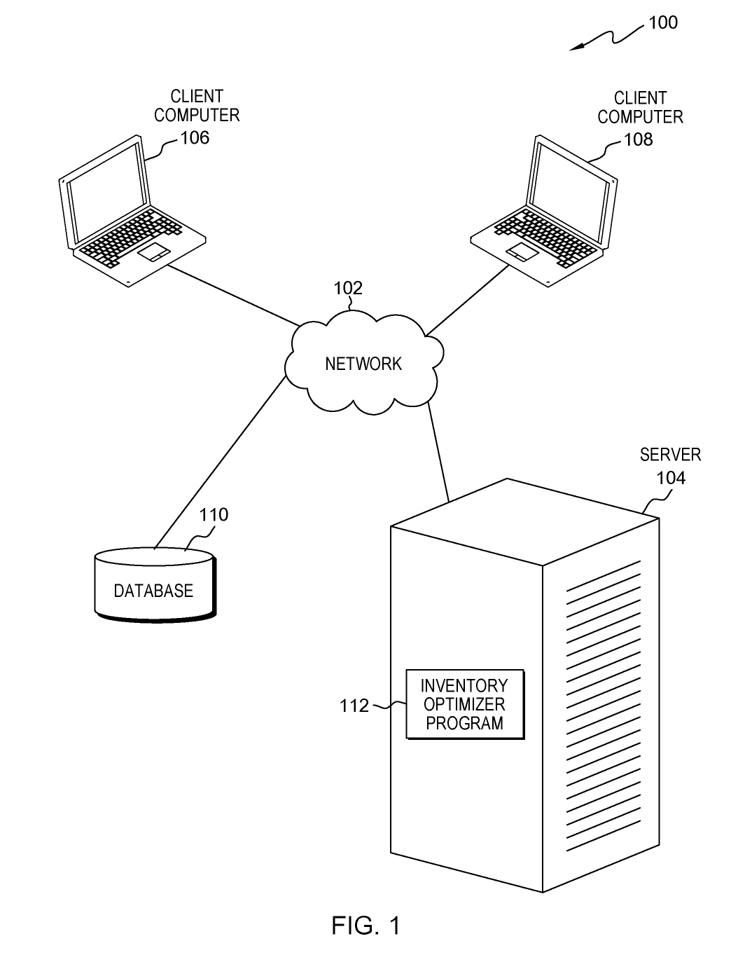

The present invention will now be described in detail with reference to the Figures. FIG. 1 is a functional block diagram illustrating a data processing environment, generally designated 100, in accordance with one embodiment of the present invention. In an embodiment, data processing environment 100 may be a distributed data processing environment. The term “distributed” can describe a computer system that includes multiple, physically distinct devices that operate together as a single computer system. FIG. 1 provides only an illustration of one implementation and does not imply any limitations with regard to the environments in which different embodiments may be made by those skilled in the art without departing from the scope of the invention as recited by the claims. FIG. 1 includes network 102, server 104, and one or more client computers, such as client computer 106 and client computer 108, and database 110.

In one embodiment, network 102 is the Internet representing a worldwide collection of networks and gateways that use TCP/IP protocols to communicate with one another. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. Server 104, client computer 106, client computer 108, and database 110 are interconnected by network 102. Network 102 can be any combination of connections and protocols capable of supporting communications between server 104, client computer 106, client computer 108, database 110, inventory optimizer program 112, and other computing devices (not shown) within data processing environment 100. FIG. 1 is intended as an example and not as an architectural limitation for the different embodiments.

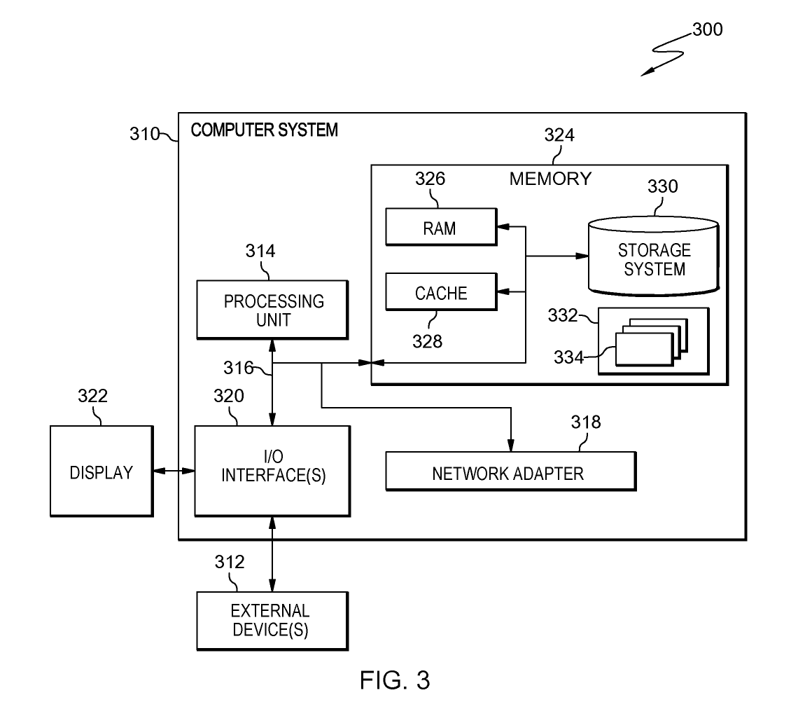

In one embodiment, server 104 may be, for example, a server computer system, such as a database server, a management server, a web server, a structured query language server, or any other electronic device or computing system capable of sending and receiving data. In another embodiment, server 104 may be a data center consisting of a collection of networks and servers providing an IT service, such as virtual servers and applications deployed on virtual servers, to an external party. In another embodiment, server 104 represents a “cloud” of computers interconnected by one or more networks, where server 104 represents a computing system utilizing clustered computers and components (e.g., database server computers, application server computers, etc.) that act as a single pool of seamless resources when accessed within data processing environment 100. This is a common implementation for data centers in addition to cloud computing applications. Server 104 may include internal and external hardware components, as depicted and described in further detail with respect to FIG. 3. In the exemplary embodiment, server 104 includes inventory optimizer program 112 for identifying a non-optimized inventory system.

In one embodiment, inventory optimizer program 112 operates on a central server, such as server 104, and can be utilized by one or more client computers, such as client computer 106 and client computer 108, via network 102. In another embodiment, inventory optimizer program 112 may be a software-based program downloaded from the central server, such as server 104, or a third-party provider (not shown), and executed on a client computer, such as client computer 106 and client computer 108, to identify a non-optimized inventory system. In yet another embodiment, inventory optimizer program 112 may include one or more software-based components, such as add-ons, plug-ins, and agent programs, etc., installed on one or more client devices, such as client computer 106 and client computer 108, to identify a non-optimized inventory system.

In one embodiment, inventory optimizer program 112 is a software-based program for identifying a non-optimized inventory system. In one embodiment, inventory optimizer program 112 provides an a posteriori view of optimization of an inventory system. In one embodiment, inventory optimizer program 112 evaluates non-optimality of an inventory system based, at least in part, on history of inventory related to events and actions. In one embodiment, inventory optimizer program 112 determines an optimal inventory policy for an inventory system during a past historical period, applies the optimal inventory policy to an actual event during the past historical period to simulate what would have happened had the optimal inventory policy been followed, and compares the simulation against the actual event during the past historical period to identify non-optimality in a decision process. For example, where inventory optimizer program 112 identifies one or more actions (e.g., decisions) in an inventory history that led to non-ideal conditions than what would have happened had an optimal inventory policy (determined posteriorly) been followed, inventory optimizer program 112 records the one or more actions as non-optimal actions. In some embodiments, one or more actions may include, without limitation, how much inventory to hold, how much inventory for safety stock, how much inventory to buy when purchasing from a supplier, how often to buy inventory, what events should trigger a decision to buy, how to review dynamic inventory on hand, how to value (i.e., account for) inventory on hand, and whether to backorder inventory, etc. In some embodiments, inventory optimizer program 112 determines an optimal inventory policy as a planning measure, prescribing to optimize an inventory system in anticipation of future events based, at least in part, on historical performance of an inventory system.

In one embodiment, inventory optimizer program 112 provides the capability to monitor an actual inventory system, determine an optimal inventory system, and compare the actual inventory system to the determined optimal inventory system to detect and diagnose non-optimal situations and anomalies. For example, inventory optimizer program 112 may evaluate and identify non-optimal inventory actions whether or not the inventory is being managed and planned using standard inventory optimization techniques. In one embodiment, inventory optimizer program 112 provides a mechanism for deriving supply chain performance measurements of interest, such as an average inventory on hand, an average inventory value over time, a number of times to zero, a number of days at zero, and a number of days below a pre-determined minimum inventory. In various embodiments, inventory optimizer program 112, when combined with a demand time series for a pre-determined interval, provides the capability to measure a service level attained, for example, as a percentage of time inventory was available to meet demands. In various embodiments, inventory optimizer program 112, when combined with a demand time series and characteristics of lead time for replenishment, provides the capability to evaluate a gap from optimality with respect to a pre-determined inventory policy. In one embodiment, inventory optimizer program 112 receives a plurality of supply chain data, including, but not limited to, transactional sales, purchase orders and receiving/adjustment data related to a product or service from each of one or more locations in a supply chain. For example, inventory, i.e., items that a supply chain company stockpiles for its use (e.g., raw materials for use in assembly, finished goods for distribution or selling to meet customer demand, etc.) presents a number of decisions that can be made in supply chain planning and operation. In one embodiment, inventory optimizer program 112 creates a set of difference equations based, at least in part, on obtained transactional sales and purchase order data, where the set of difference equations represent various dynamics of an inventory level for a product at one or more locations in a supply chain. In one embodiment, inventory optimizer program 112 identifies inconsistencies and determines a quantification correction for an inventory level of a product at each of one or more points in a time interval based, at least in part, on a set of difference equations. In one embodiment, inventory optimizer program 112 provides a notification to a user at each of one or more locations at each of one or more time intervals, where the notification highlights a measure of quantity for one or more units of inventory of a product available at one or more locations in a supply chain. In one embodiment, inventory optimizer program 112 associates a point in time, defined over a pre-determined time interval, to a quantification of an inventory level (i.e., a number of units available at the point in time).

In one embodiment, client computer 106 and client computer 108 are clients to server 104 and may be, for example, a server, a desktop computer, a laptop computer, a tablet computer, a personal digital assistant (PDA), a smart phone, a thin client, or any other electronic device or computing system capable of communicating with server 104 through network 102. For example, client computer 106 and client computer 108 may be a laptop computer capable of connecting to a network, such as network 102, to utilize a software-based program, such as inventory optimizer program 112 of server 104. In one embodiment, client computer 106 and client computer 108 represent any programmable electronic device or combination of programmable electronic devices capable of executing machine readable program instructions and communicating with other computing devices (not shown) within data processing environment 100 via a network, such as network 102. In one embodiment, client computer 106 and client computer 108 include a user interface (not shown) for submitting data queries to a database server, such as server 104. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curves of command-line interfaces, which required commands to be typed on the keyboard. The actions in GUIs are often performed through direct manipulation of the graphics elements.

In one embodiment, database 110 is a storage device (e.g., storage repository, database, etc.) interconnected with a server, such as server 104, via a network, such as network 102. In one embodiment, database 110 provides the capability to store data related to inventory systems and supply chains. For example, database 110 may include historical data records from existing inventory systems, where the historical data records may include financial records, supply chain master data, and transaction data for the inventory system.

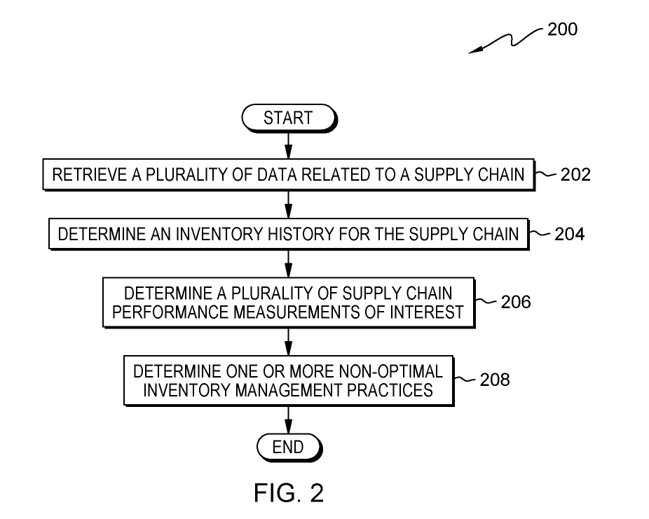

FIG. 2 depicts a flowchart depicting operational steps of an inventory optimizer program, such as inventory optimizer program 112 of FIG. 1, generally designated 200, for identifying a non-optimized inventory system, in accordance with an embodiment of the present invention.

Inventory optimizer program 112 retrieves a plurality of data related to a supply chain (202). In one embodiment, inventory optimizer program 112 retrieves a plurality of data related to a supply chain, wherein the plurality of data includes historical data from an existing supply chain system used for enterprise resource planning (ERP). In one embodiment, the plurality of data related to the supply chain may include, for example, financial records consisting of balance sheets, income statements, cash flows, invested capital and operational cost details, supply chain master data consisting of customer details, facility details, material details, stock keeping units (SKUs), vendor details, and route schedules, and transaction data consisting of product demand, shipping orders, receipts, adjustments, invoices, and purchase orders. In one embodiment, inventory optimizer program 112 retrieves the plurality of data related to the supply chain from standard data historical records stored within a database, such as database 110. In one embodiment, inventory optimizer program 112 records, over a pre-determined period of time, one or more relevant events in an inventory system (i.e., supply chain system) with a time stamp, where the one or more relevant events include, without limitation, an inventory demand, a fulfillment event, a review event, an reorder event, and a replenishment arrival, etc. In other embodiments, inventory optimizer program 112 may retrieve one or more relevant events and a plurality of associated time stamps related to a pre-determined historical period of an inventory system from a database, such as database 110.

Inventory optimizer program 112 determines an inventory history for the supply chain (204). In one embodiment, inventory optimizer program 112 determines an inventory history for the supply chain by reconstructing the inventory history based, at least in part, on the retrieved data related to the supply chain system. For example, inventory optimizer program 112 may reconstruct an inventory history by leveraging one or more relevant events with a plurality of associated time stamps and a plurality of inventory data for an inventory system during a pre-determined historical period of time. In one embodiment, inventory optimizer program 112 determines the inventory history for the supply chain by creating a set of linear difference equations based, at least in part, on transactional sales and purchase order data. In one embodiment, the set of linear difference equations represent the dynamics of an inventory level for one or more products at a location in the supply chain. In one embodiment, the set of linear difference equations may include a first linear difference equation, and a second linear difference equations, where the first linear difference equation is an expression of an inventory on hand on a first date equal to a multiplier times an inventory on hand on a previous date (first date minus 1) plus a summary of changes that occur on the first date, and where the second linear difference equation is an expression of the summary of one or more changes that occur on the first date equal to a total receipts value on the first date minus a total depletions value on the first data plus a total net adjustments value on the first date. In one embodiment, inventory optimizer program 112 constructs a model (e.g., a graph) based on the set of linear difference equations that associates a quantification of inventory level (e.g., an actual inventory on hand) to a point in time across a time series (e.g., a defined time interval, a range of dates, etc.), where the model is a depiction of the dynamics of an inventory system over the time series.

In one embodiment, inventory optimizer program 112 determines an a posteriori optimal inventory policy for demand time and lead time characteristics of a historical period of an inventory system. In one embodiment, inventory optimizer program 112 constructs a model that plots an actual inventory on hand with an optimized inventory on hand at one or more points in time across a time series (i.e., a historical period). In one embodiment, inventory optimizer program 112 may provide a notification of a quantity of units of inventory on hand to a user at each of one or more locations at each of one or more points in the time interval. In one embodiment, inventory optimizer program 112 may dynamically simulate an optimal inventory policy based, at least in part, on a posteriori optimization, where a dynamic simulation provides a time series of a plurality of reconstructed events (e.g., demand, filled demand, not filled demand, etc.) of an inventory system (e.g., a supply chain) that can be compared to a plurality of actual events of the inventory system.

Inventory optimizer program 112 determines a plurality of supply chain performance measurements of interest (206). In one embodiment, inventory optimizer program 112, based, at least in part, on the reconstructed inventory history and the data related to the supply chain system, determines a plurality of supply chain performance measurements of interest including, but not limited to, an average inventory of units on hand, an average inventory value over time, a number of times an inventory level reached a value of zero, a number of days an inventory level remained at a value of zero, and a number of days an inventory level remained below a contracted minimum value. In various embodiments, inventory optimizer program 112, when combined with a demand time series for a same time interval, measures a service level attained, such as a percentage of time an inventory level was available to meet a product demand. In some embodiments, inventory optimizer program 112 may compare one or more reconstructed time series to one or more actual time series to identify one or more non-optimal events, such as panic buys (i.e., actual replenishment sizes of inventory that were “X” times the average of inventory needed), as described in the one or more reconstructed events. In various embodiments, inventory optimizer program 112, when combined with a demand time series and a plurality of characteristics of lead times for product replenishment, determines inconsistencies from optimality with respect to an optimal inventory policy.

Inventory optimizer program 112 determines one or more non-optimal inventory management policies (208). In one embodiment, inventory optimizer program 112 utilizes the reconstructed inventory history and the plurality of supply chain performance measurements of interest to identify one or more non-optimal inventory management practices, such as panic buys. In one embodiment, inventory optimizer program 112 utilizes the reconstructed inventory history to analyze details of past inventory performance to determine a quantification correction to the inventory level of a product at each point in the time interval. In one embodiment, the quantification correction to the inventory level of a product may be a value to increase or decrease an actual inventory on hand in order to align the actual inventory on hand to an optimal inventory on hand to achieve cost savings and/or increases in service level attainment. In various embodiment, inventory optimizer program 112 may utilize the reconstructed inventory history to analyze details of past inventory performance to detect a violation of an inventory floor for purposes of assessing vendor penalties. In various embodiment, inventory optimizer program 112 may utilize the reconstructed inventory history to analyze details of past inventory performance to detect a non-optimal time series pattern, such as receipts at an end of a week or on a weekend, where detection of the non-optimal time series pattern may guide framers of future inventory policy toward eliminating the non-optimal time series to realize reductions in working capital costs, thereby improving the efficiency and effectiveness of an inventory system. In various embodiment, inventory optimizer program 112 may utilize the reconstructed inventory history to analyze details of past inventory performance to detect a missed opportunity to react to external events that may yield opportunistic purchases. In some embodiments, inventory optimizer program 112 utilizes identified non-optimality for root cause analysis to highlight actions in history that did not follow an optimal inventory policy, as well as one or more outlier actions (e.g., extreme actions, such as panic buys), and structure future inventory policy to avoid the one or more outliers as a cost-saving measure to improve efficiency in an inventory system. In one embodiment, inventory optimizer program 112 utilizes identified non-optimality for providing adjustments to demand and lead time models used in an optimal inventory policy to improve future management and operation of an inventory system.

FIG. 3 depicts a block diagram of components of data processing system, such as server 104 of FIG. 1, generally designated 300, in accordance with an illustrative embodiment of the present invention. It should be appreciated that FIG. 3 provides only an illustration of one implementation and does not imply any limitations with regard to the environments in that different embodiments may be implemented. Many modifications to the depicted environment may be made.

In the illustrative embodiment, server 104 in data processing environment 100 is shown in the form of a general-purpose computing device, such as computer system 310. The components of computer system 310 may include, but are not limited to, one or more processors or processing unit(s) 314, memory 324, and bus 316 that couples various system components including memory 324 to processing unit(s) 314.

Bus 316 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 310 typically includes a variety of computer system readable media. Such media may be any available media that is accessible by computer system 310, and it includes both volatile and non-volatile media, removable and non-removable media.

Memory 324 can include computer system readable media in the form of volatile memory, such as random access memory (RAM) 326 and/or cache memory 328. Computer system 310 may further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk, such as a CD-ROM, DVD-ROM, or other optical media can be provided. In such instances, each can be connected to bus 316 by one or more data media interfaces. As will be further depicted and described below, memory 324 may include at least one computer program product having a set (e.g., at least one) of program modules that are configured to carry out the functions of embodiments of the invention.

Program/utility 332, having one or more sets of program modules 334, may be stored in memory 324 by way of example, and not limitation, as well as an operating system, one or more application programs, other program modules, and program data. Each of the operating systems, one or more application programs, other program modules, and program data, or some combination thereof, may include an implementation of a networking environment. Program modules 334 generally carry out the functions and/or methodologies of embodiments of the invention as described herein. Computer system 310 may also communicate with one or more external device(s) 312, such as a keyboard, a pointing device, a display 322, etc., or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still yet, computer system 310 can communicate with one or more networks, such as a local area network (LAN), a general wide area network (WAN), and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives, and data archival storage systems may be used in conjunction with computer system 310.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

What is claimed is:

1. A method for improving inventory system management, the method comprising:
retrieving, by one or more computer processors, a plurality of data related to a supply chain from a plurality of historical records, wherein the plurality of data related to the supply chain includes transactional sales and purchase order data for one or more products on hand at each of a plurality of locations in the supply chain of an inventory system, and wherein retrieving includes recording, over a pre-determined time period, one or more relevant events in the supply chain with a time stamp, where the one or more relevant events include an event selected from a group consisting of an inventory demand, a fulfillment event, a review event, an reorder event, and a replenishment arrival, and retrieving the one or more relevant events and a plurality of associated time stamps related to a pre-determined historical period of time in the supply chain;
determining, by the one or more computer processors, an inventory history for the supply chain, wherein determining includes reconstructing the inventory history based, at least in part, on the plurality of data related to the supply chain;
creating, by the one or more computer processors, a set of linear difference equations based, at least in part, on the plurality of data related to the supply chain, wherein the set of linear difference equations represent a plurality of changes of an inventory level for the one or more products on hand at each of the plurality of locations in the supply chain, and wherein the set of linear difference equations includes a first linear difference equation and a second linear difference equation, wherein the first linear difference equation is an expression of an inventory on hand on a first date equal to a multiplier times an inventory on hand on a previous date plus a summary of one or more changes that occur on the first date, and the second linear difference equation is an expression of the summary of the changes that occur on the first date equal to a total receipts value on the first date minus a total depletions value on the first date plus a total net adjustments value on the first date;
determining, by the one or more computer processors, a plurality of supply chain performance measurements of interest, wherein determining includes comparing one or more reconstructed time series to one or more actual time series to identify one or more non-optimal inventory events;
determining, by the one or more computer processors, one or more non-optimal inventory management practices, wherein determining includes determining a quantification correction to an inventory level of a product at each of a plurality of points in a time interval through utilizing a reconstructed inventory history and the plurality of supply chain performance measurements of interest, wherein the quantification correction to the inventory level of the product is a value to increase or decrease an actual inventory on hand in order to align the actual inventory on hand to an optimized inventory on hand;
determining, by the one or more computer processors, an optimal inventory policy for a plurality of characteristics of a historical period of an inventory system;
constructing, by the one or more computer processors, a model plotting the actual inventory on hand with the optimized inventory on hand at one or more points in time across the pre-determined historical period of time;
simulating, by the one or more computer processors, the optimal inventory policy based, at least in part, on a posteriori optimization, where a dynamic simulation provides a time series of a plurality of reconstructed events of the inventory system compared to a plurality of actual events of the inventory system;
providing, by the one or more computer processors, a notification to a user at each of the plurality of locations in the supply chain at each point in the time interval informing a quantity representing the inventory level for the one or more products on hand at each of the plurality of locations in the supply chain; and
providing, by the one or more computer processors, a function, defined over an input time interval, that maps a point in time to the quantification of the inventory level for the one or more products on hand at each of the plurality of locations in the supply chain.
